(19) United States
(12) Patent Application Publication
(10) Pub. No.: US 2010/0135026 A1
(43) Pub. Date: Jun. 3, 2010

(54) REFLECTOR SYSTEM FOR ELECTRODE-LESS PLASMA SOURCE

(75) Inventors: Kaichang Lu, Birmingham (GB); Martin Soerensen, Roende (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Martin Professional A/S, Aarhus N (DK)

(21) Appl. No.: 12/327,331

(22) Filed: Dec. 3, 2008

(30) Foreign Application Priority Data
Dec. 2, 2008 (DK) PA 2008 01696

(51) Int. Cl. F21V 7/00

(52) U.S. Cl. 362/297

(57) ABSTRACT

The present invention relates to a lamp primarily for projectors, which lamp comprises at least one light source, which light source is formed of at least one Electrode Less Plasma Source (ELPS), which light sources comprises a light bulb comprising a plasma material, which plasma material is excited to emit light by electromagnetic radiation, which lamp comprises at least a first reflector, which light source is placed inside the first reflector, which lamp further comprises at least a second reflector. The present invention further concerns a method for forming a beam of light generated from an ELPS light source, where the light is concentrated by a first reflector and where the light is further concentrated in a second reflector.

### FIELD OF THE INVENTION

The present invention relates to a lamp primarily for projectors, which lamp comprises at least one light source, which light source is formed of at least one Electrode Less Plasma Source (ELPS), which light sources comprises a light bulb comprising a plasma material, which plasma material is excited to emit light by electromagnetic radiation, which lamp comprises at least a first reflector, which light source is placed inside the first reflector, which lamp further comprises at least a second reflector.

The present invention further concerns a method for forming a beam of light generated from an ELPS light source, where the light is reflected by a first reflector and where the light is further reflected in a second reflector.

The present invention further concerns a light source and reflector system, which light source is formed of at least one Electrode Less Plasma Source (ELPS), which light sources comprises a light bulb comprising a plasma material, which plasma material is excited to emit light by electromagnetic radiation, which reflector system comprises at least a first reflector, which light source is placed inside the first reflector, which reflector system further comprises at least a second reflector

### BACKGROUND OF THE INVENTION

Electrode Less Plasma Source (ELPS) are known light sources and comprises a light bulb with a plasma material, where the plasma material would emit light when it is exited e.g. by electromagnetic radiation.

The ELPS could for instance be used as light sources in different light fixtures for illumination purposes and the light bulb of the ELPS is typical in this connection integrated into a reflector which reflects the light emitted by the plasma material into a predefined direction. The ELPS light bulb is integrated into an elliptic or parabolic reflector such that the light from the ELPS light bulb is focused or collimated. The ELPS light bulb is thus typical positioned in/near the focal point of the reflectors.

A large part of the ELPS light bulb is integrated in to a waveguide body called a puck into which the electromagnetic radiation is connected for instance by an antenna integrated into the waveguide. It is difficult to position the light bulb of the ESLS at the focus point of the reflector, as the puck is typical much larger than the light bulb and a part of the puck would further block some of the light if the entire ELPS is positioned inside a large elliptic or parabolic reflector. The elliptic or parabolic reflector is in other embodiments constructed such the reflector just fits around the ELPS light bulb. The light bulb will as a consequence be considered as an extended light source rather than a point source positioned in the focal point of the reflector. A large amount of the emitted light would thus be lost in the optical system, as the optical system is often optimized according the focal point of the reflector. The light is further not sufficiently equally distributed across the light beam at a focal/gate/gobo plane, which is important in connection with imaging systems such as projectors where a video display is imaged by projection onto a screen or a Gobo system where a gobo shape is imaged onto a surface. E.g. in moving heads light fixtures or scanner light fixtures, where an image or shape positioned at the focal/gate/gobo plane are imaged at a surface some distance away from the focal/gate/gobo plane. Yet another aspect is the fact that the ELPS light bulb must be positioned very precise inside the elliptic or parabolic reflector in order to achieve the wanted optical effect.

U.S. Pat. No. 6,737,809 concerns a dielectric waveguide integrated plasma lamp (DWIPL) with a body consisting essentially of at least one dielectric material having a dielectric constant greater than approximately 2, and having a shape and dimensions such that the body resonates in at least one resonant mode when microwave energy of an appropriate frequency is coupled into the body. A bulb positioned in a cavity within the body contains a gas-fill which when receiving energy from the resonating body forms a light-emitting plasma.

US 2001/0035720 concern in one aspect a plasma lamp comprising a gas envelope that is constructed from ceramic material and a sapphire window rather than quartz. According to another aspect a plasma lamp comprising an RF structure for the radio wave radiation and an envelope for housing the excitation gas that are formed so as to constitute a single, integrated ceramic structure. According to yet another aspect a plasma lamp comprising a waveguide structure having solid material such as ceramic rather than air for the dielectric and a gas housing made of a combination of solid ceramic and a sapphire window. In this way, the separate quartz gas envelope and air-filled waveguide structure employed in the prior art are replaced by a single, integrated structure.

WO 2007/079496 concerns an electrode less plasma lamp comprising a lamp body including a solid dielectric material. The lamp includes a bulb received at least partially within an opening in the solid dielectric material and a radio frequency (RF) feed configured to provide power to the solid dielectric material. A conductive material is provided adjacent to the bulb to concentrate the power proximate the bulb. The conductive material may be located below an upper surface of the solid dielectric material. The conductive material may modify at least a portion of an electric field proximate the bulb so that the portion of the electric field is oriented substantially parallel to an upper surface of the lamp body.

### DESCRIPTION OF THE INVENTION

The object of the present invention is to increase the light output from an ELPS light source in a projector. A further object of the invention is to achieve a mostly homogeneous light beam.

This can be achieved by the second reflector is formed as a cone, which cone comprises a highly reflective inner surface, in which cone parts of the generated light is multi reflected at the inner side of the cone.

By using the second reflector for further reflecting and concentrating the light beam can be achieved, that the lamp can be designed with a length much smaller than the length of traditional lamps. This can lead to a higher light output from the lamp. The cone formed reflector performs a multi reflection of part of the light, which generates a mostly uniform beam of light at the end of the conic reflector. The light beans generated by the light source in a direction towards the reflector are by the conic reflector partly aligned to a direction mostly following the centre line of the reflector.

The first reflector can be ellipse formed, where the ELPS light source can be placed in relation to a centre line of the ellipse formed reflector. Hereby can a traditional reflector be used around the light source, and the conic reflector can be placed after the ellipse formed reflector.

The ellipse formed reflector can end after the half axis of the ellipse. Hereby is the part of the light beam deviating most from the direction of the centre line reflected back into the ellipse formed reflector.

The first reflector can be parabolic, where the ELPS light source can be placed in relation to a centre line of the parabolic formed reflector. The parabolic reflector is an alternative to the ellipse formed reflector

The first reflector can be conic, where the ELPS light source can be placed in relation to a centre line of the conic formed reflector. In relation to ELPS light sources with a relative small light generating bulb the conic first reflector is directing the light generated in a direction perpendicular or even backwards in to the front direction, where the second reflector is mixing the light into a mostly uniform beam. Hereby it is achieved that most of the light from the ELPS light source is collected by the reflector system.

A color filter or a dimmer can be placed between the first and the second reflector. Hereby can achieved that the light is mixed further along the conic reflector at a very homogeneous beam of light is achieved in the conic reflector.

By a method as described in the preamble to claim 7 the second reflector is cone shaped, in which cone shaped reflector the light is concentrated into a mostly homogenous light beam.

Hereby is achieved a homogeneous beam of light in relation to traditional reflectors. In the same time the output light is increasing so much more of the electric power used for the light source is transmitted as light at the outlet of the conic reflector.

The second reflector can be formed as a cone, which cone comprises a highly reflective inner surface, in which cone parts of the generated light is multi reflected at the inner side of the cone.

Hereby can be achieved that the reflectors are much smaller than reflectors of lamps using normal light bulbs designed with electrodes. The use of the second conic reflector can result in a mostly homogeneous beam of light, which beam of light can be used in a projector.

A color filter or a dimmer can be placed between the first and the second reflector. Hereby can achieved that the light is mixed further along the conic reflector at a very homogeneous beam of light is achieved in the conic reflector

### DESCRIPTION OF THE DRAWING

FIG. 1 illustrates an ESLP integrate into a reflector according to prior art.

FIG. 2 illustrates an ESLP integrated into a reflector according to a first embodiment of the present invention;

FIG. 3 illustrates an ESLP integrated into a reflector according to a second embodiment of the present invention;

FIG. 4 illustrates an ESLP integrated into a reflector with a dimming or filtering device according to a forth embodiment of the present invention;

FIG. 5 illustrates an ESLP integrated into a reflector with a dimming or filtering device according to a fifth embodiment of the present invention;

FIG. 6 illustrates the ESLP reflector system of FIG. 3 integrated with an optical imaging system;

FIG. 7 illustrates the prior art ESLP reflector system of FIG. 1 integrated with an optical imaging system;

FIG. 8 illustrates a graph of the relative intensity across the gate plane of the optical systems of FIGS. 6 and 7.

### DETAILED DESCRIPTION OF THE INVENTION

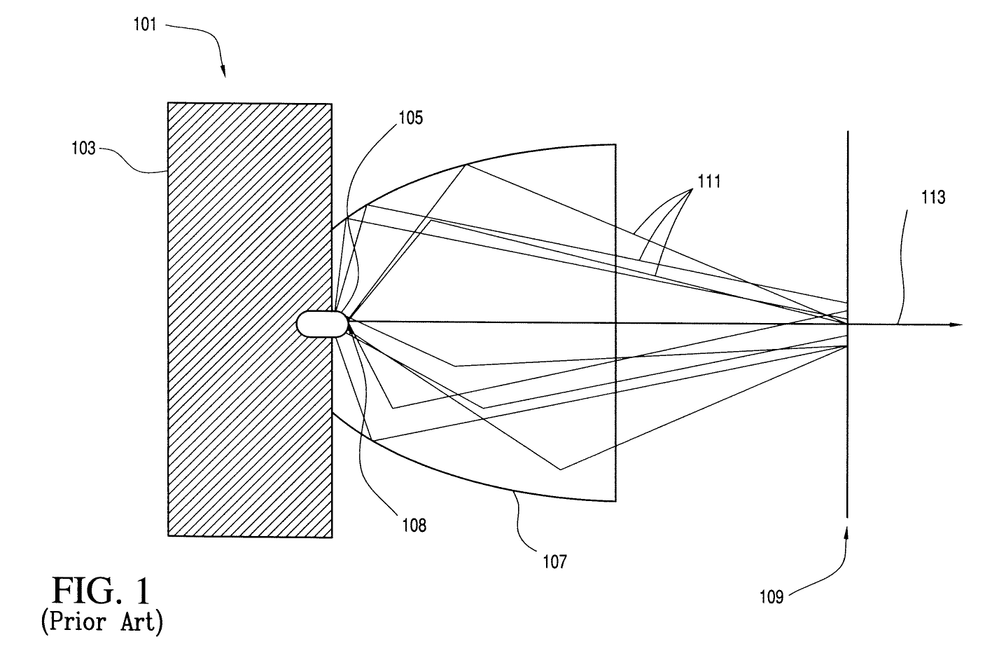

FIG. 1 illustrates a cross sectional view of an ESLP 101 integrate into a spherical elliptic reflector 107 according to prior art. The ESLP 101 comprises a light bulb 105 with a plasma material and a waveguide body 103 called a puck. Electromagnetic radiation is guided into the puck 103, e.g. by an antenna (not shown) integrated into the waveguide body and thereafter into the light bulb where the electromagnetic radiation would excite the plasma material whereby optical light is created. An elliptic reflector 107 is positioned around the light bulb 103 such that the light bulb is positioned in the focus point of the elliptic reflector. The light beams 111 (only some of the light beams are illustrated) emitted from the light bulb will be reflected by the elliptic reflector 107 and directed towards a gate/gobo/focal plane 109 where e.g. a Gobo or image, which are to be projected and imaged a distance from the ESLP, is positioned. Line 113 illustrates the center line of the optical path.

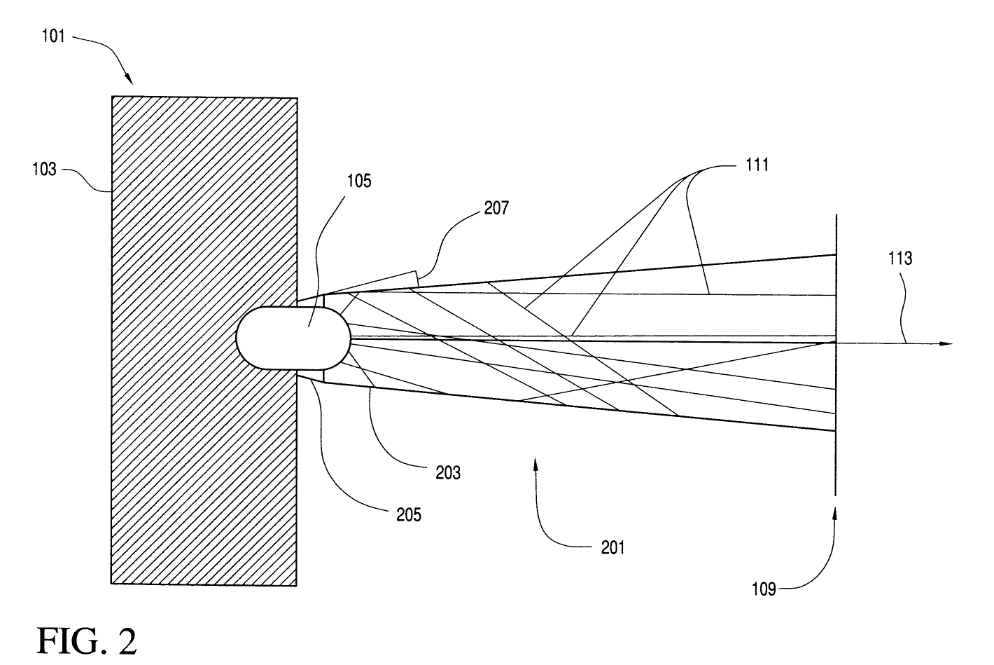

FIG. 2 illustrates a cross sectional view of an ESLP 101 integrated into a spherical reflector 201 according to a first embodiment of the present invention. The ESLP is similar to the ESLP illustrated in FIG. 1 and the reflector 201 comprises a first reflector 205 and a second reflector 203. The ESLP light bulb 103 is placed inside the first reflector 205 and the second reflector 203 is cone shaped and has a highly reflective inner surface. The light beams 111 (only some of the light beams are illustrated) emitted from the light bulb will be multiple reflected by the reflector 201 and be directed towards a gate/gobo/focal plane 109 placed at the end of the reflector 201. The first reflector 205 directs the light beams that are emitted backwards and/or outwards in relation the central optical axis 113 from the light bulb into the second reflector 203. The first reflector 205 is in this embodiment cone shaped has a larger cone angle compared to the cone angle of the second reflector. The difference in cone angle is illustrated by angle 207. The result is, that the backward and/or outward emitted light beams would be reflected into the second reflector and propagate longer along the optical axis before it hit the wall of the second reflector. The number of reflections on the second reflector is hereby reduced and thus lesser intensity is lost due the reflections. The cone shaped second reflector 203 acts as a light pipe and the light would be mixed up and nearly equally distributed across the gate/gobo/focal plane. The first reflector 205 and second reflector can in another embodiment have identical cone angles and can thus be constructed in one piece.

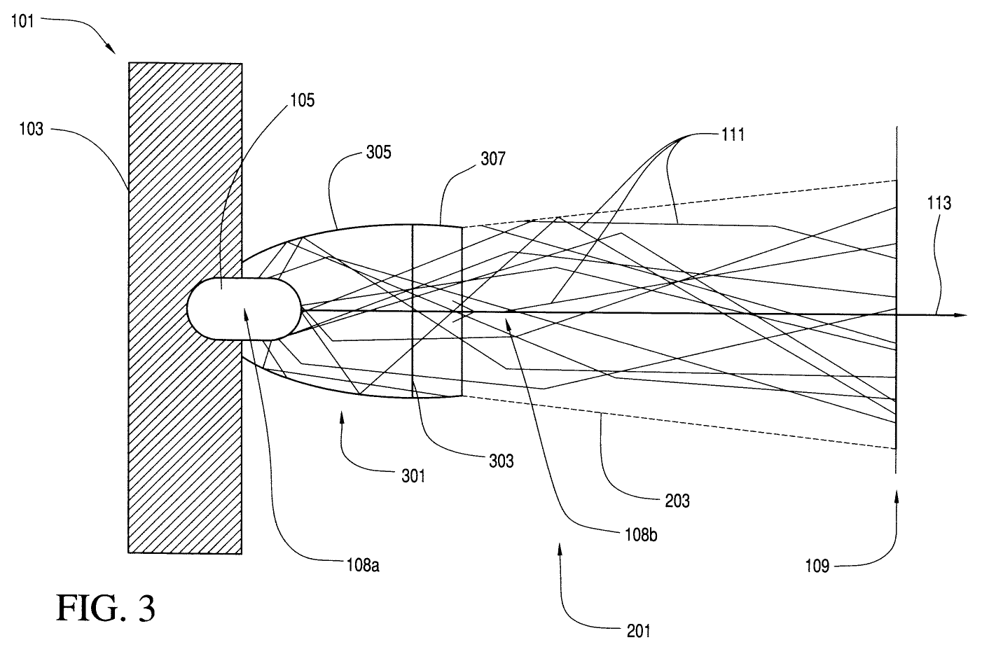

FIG. 3 illustrates a cross sectional view of an ESLP 101 integrated into a spherical reflector 201 according to a second embodiment of the present invention. The ESLP is similar to the ESLP illustrated in FIG. 1 and the reflector 201 comprises a first reflector 205 and a second reflector 301. The ESLP light bulb 103 is placed inside the first reflector 301 and the second reflector 203 is cone shaped and has a highly reflective inner surface. The first reflector is in this embodiment a spherical shaped elliptic reflector which is positioned around the light bulb such that the light bulb extends substantially equally around a first focal point 108a of the elliptic first reflector 301. The light beams 111 (only some of the light beams are illustrated) emitted from the light bulb will be reflected and directed into the second reflector 203 by the first refectory 301. The elliptic reflector is further extended such that it ends after the half axis 303 of the elliptic reflector and the elliptic reflector comprises thus a first part 305 and a second part 307. The light beams that hit the second part 307 will be directed substantially towards the second focus point 108b of the elliptic reflector and is hereby ensured that the light beams that would propagate substantially along the sides of the cone shaped reflector 203 would be directed towards the opposite side of the cone shape reflector 201, whereby a better mixing of the light beams are achieved. The first reflector 301 directs further the light beams that are emitted backwards and/or outwards in relation the central optical axis 113 from the light bulb 105 into the second reflector 203. The cone shaped second reflector 203 acts as a light pipe and the light would be mixed up and nearly equally distributed across the gate/gobo/focal plane. In other word a mostly uniform light beam is created at the gate/gobo/focal plane 109 at the end of the second reflector 203. The result is that most of the light emitted by the light bulb would be transmitted to the gate/gobo/focal plane and at the same time be equally distributed across the gate/gobo/focal plane.

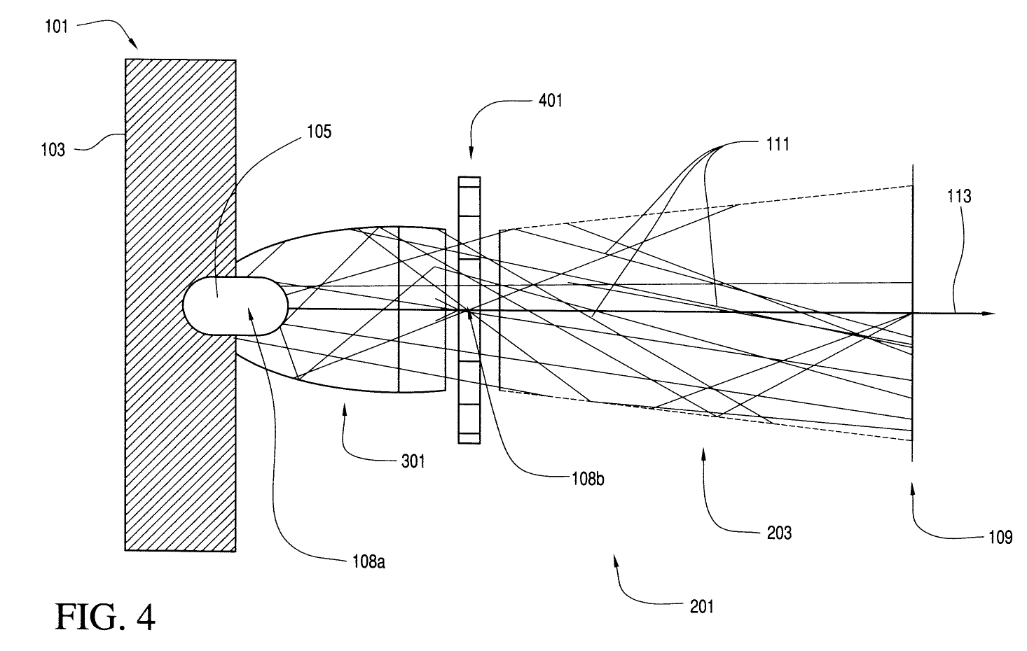

FIG. 4 illustrates a cross sectional view of an ESLP 101 integrated into a spherical reflector 201 according to the second embodiment of the present invention of FIG. 3. The first reflector 301 and second reflector 203 are in this embodiment separated such that a mechanical dimming/color filtering device 401 can be inserted between the first reflector 301 and the second reflector 201. The dimming/color filtering device is in the illustrated embodiment positioned in/near the second focal point 108b of the elliptic reflector where the beam diameter is small. The size of the dimming/color filtering device can thus be minimized. The dimming/color filtering device can be embodied as known in the art of entertainment lightning systems e.g. as two scalloped dimming plates with frost filters described by U.S. Pat. No. 6,241,366 or any other dimming apparatus for instance the ones described by U.S. Pat. No. 5,053,934, WO02/021041A1, WO06/111885A1 or WO08/086806A1; color wheels or CMY flags (e.g. described by EP1234197) etc. The reflector system could further comprise an actuator which could be adapted to separate the first reflector 301 and the second reflector automatically. The reflector system 201 can thus have a first position where the first 301 and second 203 reflector are positioned together for maximum light output and a second dimming/filtering position where the mechanical dimmer/color filtering device is inserted between the first 301 and the second 203 reflector.

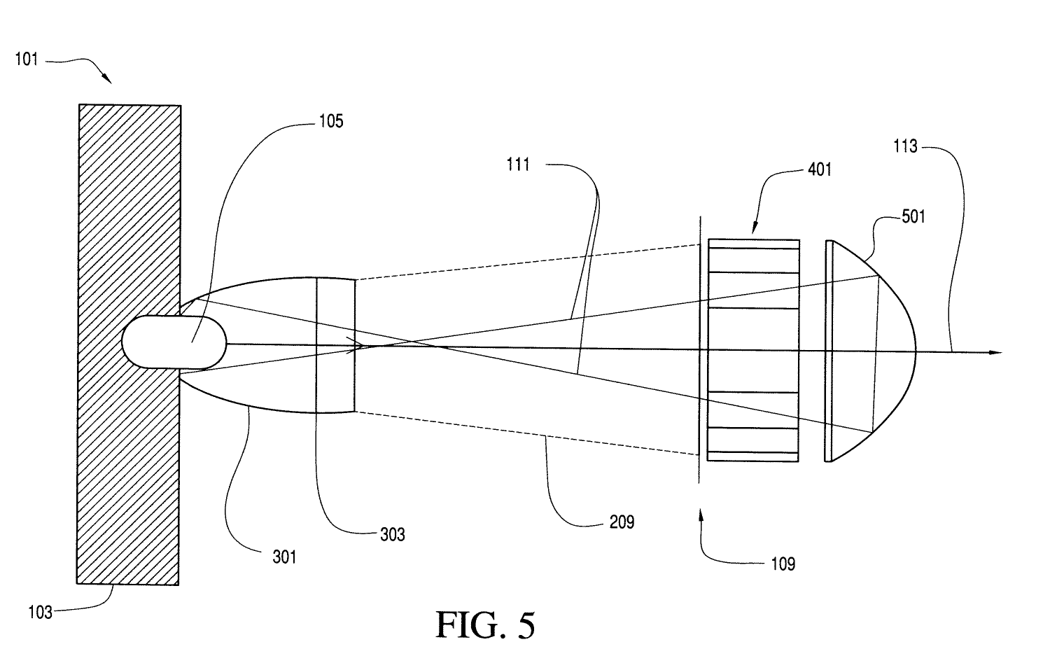

FIG. 5 illustrates a cross sectional view of an ESLP 101 integrated into a spherical reflector 201 according to the second embodiment of the present invention of FIG. 3. A dimming/color filtering device 401 is in this embodiment positioned after the gate/gobo/focal plane. The embodiment comprises further an imaging lens 501 adapted to image the gate/gobo/focal plane some distance along the optical axis. The result is the gate/gobo/focal plane would be imaged and the dimmer/color filtering device defocused whereby the teeth of dimmer blades or CMY flags would not be imaged.

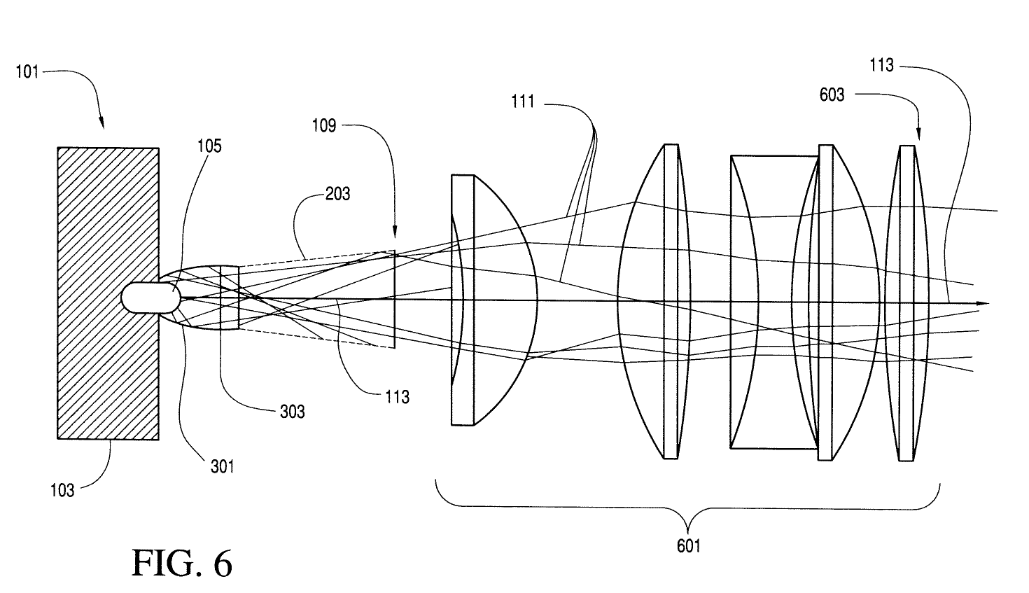

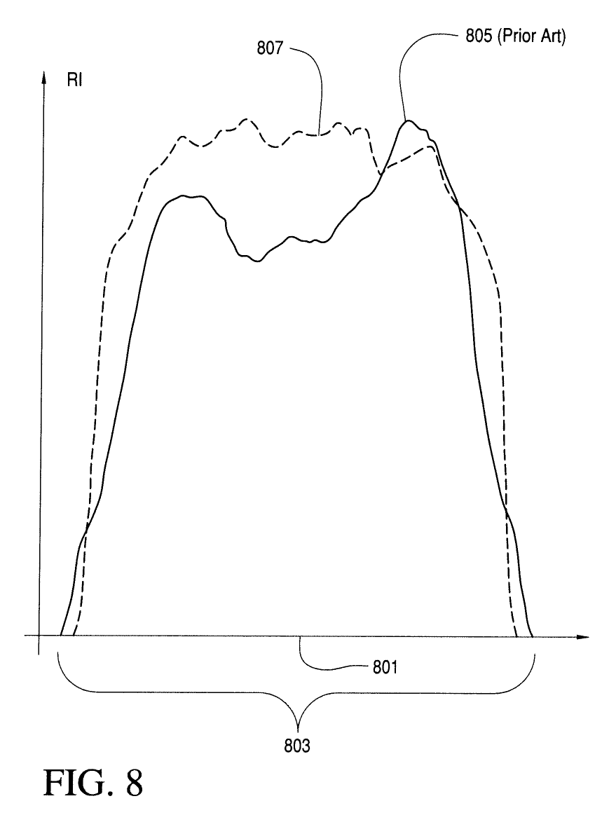

FIG. 6 illustrates the ESLP reflector system of FIG. 3 integrated with an optical imaging system 601 that projects and image the gate/gobo/focal plane at some distance from the lens exit 603. This system is used to simulate the light output and the light distribution across (illustrated in FIG. 8) the gate/gobo/focal plane and the light output at the lens exit 603

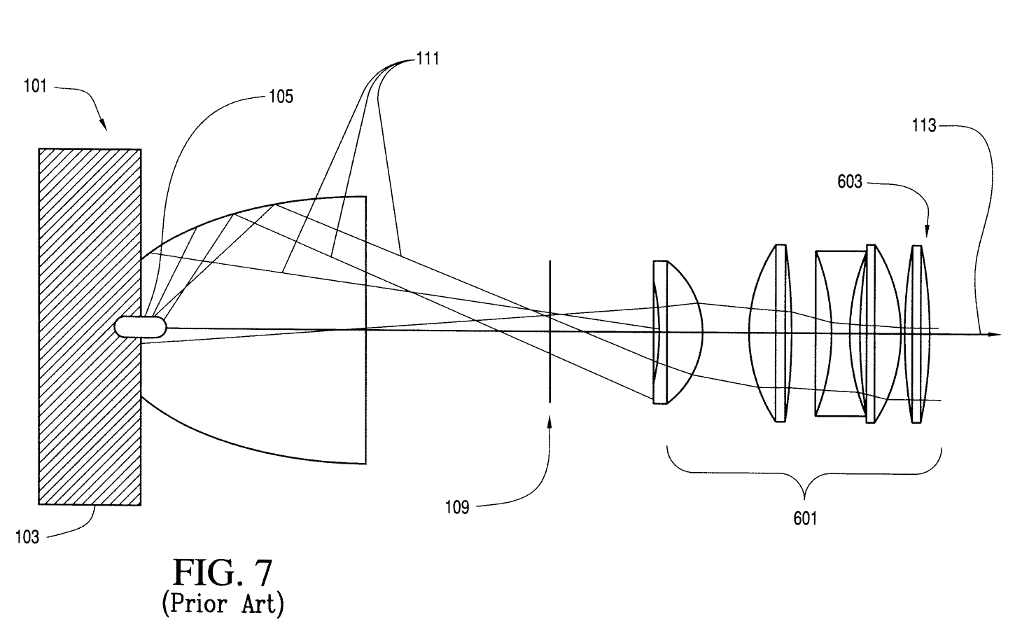

FIG. 7 illustrates the prior art ESLP reflector system of FIG. 1 integrated with an optical imaging system 601 that projects and image the gate/gobo/focal plane at some distance from the lens exit 603. This system is used to simulate the light output and the light distribution across (illustrated in FIG. 8) the gate/gobo/focal plane the light output at the lens exit 603.

Computer simulations (in Zemax) of the two optical systems illustrated in FIG. 6 and FIG. 7 has been performed in order to illustrate the effect achieved by the reflector system according to the present invention. The two simulations were both performed based on a measurement of the light distribution of an ESLP light sources delivered and produced by company called LUXIM. These measurements were used to simulate the light source 101. Further identical imaging system 601 was inserted after the two reflector systems. The imaging systems used in the simulations is identical to the imaging system of the moving head light fixture called MAC150 produced by Martin Professional. The results from the simulations are shown in table 1.

TABEL 1
Results of simulation of the image system of FIG. 6 and 7

| | The optical system | The prior art optical |
|---|---|---|
| | of FIG. 6 | system of FIG. 7 |
| Light source (101) | Measured light | Measured light |
| | distribution of | distribution of |
| | LUXIM ESLP light | LUXIM ESLP light |
| | source | source |
| Source flux | 17000 | 17000 |
| [lumen] | | |
| Reflector system | Illustrated in figure | Illustrated in FIG. 1 |
| | FIG. 3 | |
| Reflection index of | 95% | 95% |
| reflector system | | |
| Imaging system | MAC150 imaging | MAC150 imaging |
| | system, 601 | system, 601 |
| | (imaging system 601 | (imaging system 601 |
| | in FIG. 6 and 7 are | in FIG. 6 and 7 are |
| | identical) | identical) |
| Transmittance index of | 99% | 99% |
| imaging system | | |
| Gobo diameter | 25 | 25 |
| [mm] | | |
| Flux at Gate/Gobo/ | 13685 | 9290 |
| focal plane plane | | |
| 109 [Lumen] | | |
| Efficiensy at Lens exit | 80.5% | 54.6% |
| 603 efficiency | | |
| Efficiency at Gate/Gobo/ | 90.5% | 61.3% |
| focal plane 109 | | |
| Distance from light | 60 | 194 |
| bulb 105 to gate/gobo/ | | |
| gocal plane [mm] | | |

Form the simulations it is clearly that the reflector system according to the present invention dramatically improves the efficiency both at the gate/gobo/focal plane 109 and at the Lens Exit. The efficiency at the gobo/focal plane 109 is improved by 80.5/54.6−100%=47.4% and at the Lens exit 603 by 90.5/61.3−100%=47.7%.

Further it can be seen that the length of the reflector system is reduced from 195 mm to 60 mm.

FIG. 8 illustrates a graph of the relative intensity across the gate/gobo/focal plane 109 plane of the optical systems of FIG. 6 and 7. The relative intensity RI (computer simulated) (at the second axis) is illustrated across the gate/gobo/focal plane (at the first axis) 109 of the imaging systems of FIG. 6 and 7. Point 801 indicate the center of the gate/gobo/focal plane and the bracket 803 illustrates the width of the gate/gobo/focal plane. The dotted line 807 illustrates the relative intensity across the gate/gobo/focal plane of the imaging system of FIG. 6. The strait line 805 illustrates the relative intensity across the gate/gobo/focal plane of the prior art imaging system of FIG. 7. The same ESLP 101 source have been used in both imaging systems an it can be seen that light distribution of the imaging system of FIG. 6 is more equal across the gate/gobo/focal plane than compared to the light distribution of the prior art imaging system of FIG. 7.

1. Lamp primarily for projectors, which lamp comprises at least one light source, which light source is formed of at least one Electrode Less Plasma Source (ELPS), which light sources comprises a light bulb comprising a plasma material, which plasma material is excited to emit light by electromagnetic radiation, which lamp comprises at least a first reflector, which light source is placed inside the first reflector, which lamp further comprises at least a second reflector, whereby the second reflector is formed as a cone, which cone comprises a highly reflective inner surface, in which cone parts of the generated light is multi reflected at the inner side of the cone.

2. Lamp according to claim 1, whereby the first reflector is ellipse formed, where the ELPS light source is placed in relation to a centre line of the ellipse formed reflector.

3. Lamp according to claim 2, whereby the ellipse formed reflector is ending after the half axis of the ellipse.

4. Lamp according to claim 1, whereby the first reflector is parabolic, where the ELPS light source is placed in relation to a centre line of the parabolic formed reflector.

5. Lamp according to claim 1, whereby the first reflector is conic, where the ELPS light source is placed in relation to a centre line of the conic formed reflector.

6. Lamp according to claim 1, whereby a color filter or a dimmer (401) is placed between the first (301) and the second reflector (203).

7. Method for forming a beam of light generated from an ELPS light source, where the light is reflected by a first reflector and where the light is further reflected in a second reflector, whereby the second reflector is cone shaped, in which cone shaped reflector the light is reflected into a mostly homogenous light beam.

8. Light source and reflector system, which light source is formed of at least one Electrode Less Plasma Source (ELPS), which light sources comprises a light bulb comprising a plasma material, which plasma material is excited to emit light by electromagnetic radiation, which reflector system comprises at least a first reflector, which light source is placed inside the first reflector, which reflector system further comprises at least a second reflector, whereby the second reflector is formed as a cone, which cone comprises a highly reflective inner surface, in which cone parts of the generated light is multi reflected at the inner side of the cone.

9. Light source and reflector system according to claim 8, whereby a color filter or a dimmer is placed between the first and the second reflector.
